(19) United States
(12) Patent Application Publication
(10) Pub. No.: US 2026/0016743 A1
(43) Pub. Date: Jan. 15, 2026

(54) UNIVERSAL DIGITAL DENTAL X-RAY SENSOR HOLDER WITH ADJUSTABLE AIMING APPARATUS AND METHOD

(71) Applicant: Adentage Inc., Chicago, IL (US)

(72) Inventor: Zhenhui Huang, Chicago, IL (US)

(21) Appl. No.: 18/768,795

(22) Filed: Jul. 10, 2024

(51) Int. Cl. G03B 42/04

(52) U.S. Cl. CPC G03B 42/042; G03B 42/047

(57) ABSTRACT

A universal digital dental x-ray sensor holder with adjustable aiming apparatus is provided for holding a digital dental x-ray sensor in a desired location by an apparatus enabled by this disclosure. The universal digital dental x-ray sensor holder with adjustable aiming apparatus may include an aiming module, guide rail, slider, arm, sensor attachment module, compression accessory and sensors and interchangeability of same. A method for holding a digital dental x-ray sensor in a desired location by an apparatus enabled by this disclosure using the universal digital dental x-ray sensor holder with adjustable aiming apparatus is also provided.

### FIELD OF THE INVENTION

The present disclosure relates to a universal digital dental x-ray sensor holder with adjustable aiming apparatus. More particularly, the disclosure relates to holding a digital dental x-ray sensor in a desired location by an apparatus enabled by this disclosure.

### BACKGROUND

Taking intraoral x-rays can be a hassle. The various pieces of equipment used that must correspond with the x-ray view can make operating a cumbersome collection of equipment even more of a hassle. Dentists, and similar people skilled in the art, find it difficult to keep track of all the separate x-ray positioning tools for all of the different x-ray views a user may need. The most common x-ray views include an anterior view, a posterior view, a horizontal bitewing view, a vertical bitewing view, and an endodontic view. With each “view” comes its separate aiming module, arm, and sensor attachment module. If a patient needs more than one different x-ray view taken, it is easy to get the x-ray positioning tools mixed up with one another. Additionally, the equipment of the prior art lacks the capability to fine tune and adapt each x-ray view as needed due to the rigidness of the current design.

Therefore, a need exists to solve the deficiencies present in the prior art. What is needed is an apparatus that can be finely adjusted to take multiple different x-ray views. What is needed is a machine that can be configured to assist in the aiming of the x-ray with a desired view and orientation. What is needed is an adjustable aiming apparatus that can be adjusted based on a user's measurements and shape of the user's oral cavity. What is needed is a method of positioning and adjusting a digital dental x-ray sensor with relation to the oral cavities of a patient. What is needed is an adjustable aiming ring that can be used with a digital dental x-ray holder that can be fine tuned to fit various sizes of sensors to increase sensor accuracy due to improved positioning.

### SUMMARY

An aspect of the disclosure advantageously provides an apparatus that can be finely adjusted to take multiple different x-ray views. An aspect of the disclosure advantageously provides a machine that can be configured to assist in the aiming of the x-ray with a desired view and orientation. An aspect of the disclosure advantageously provides a universal digital dental x-ray sensor holder with adjustable aiming apparatus that can be adjusted based on a user's measurements and shape of the user's oral cavity. An aspect of the disclosure advantageously provides a method of positioning and adjusting a digital dental x-ray sensor with relation to the oral cavities of a patient. An aspect of the disclosure advantageously provides an adjustable aiming ring that can be used with a digital dental x-ray holder that can be fine tuned to fit various sizes of sensors to increase sensor accuracy due to improved positioning.

Accordingly, the disclosure may feature an adjustable x-ray sensor holder apparatus including an aiming module, slider, and arm. The aiming module may further include a perimeter length of material having a substantial aperture through which x-ray imaging may be oriented and a guide rail located on a portion of the perimeter length of material. The guide rail may include notches located substantially along a guide rail length of the guide rail relative to guide rail sections. The slider may be selectively positioned about one of the guide rail sections. The arm may be operatively connected to the slider at a variable arm depth via a slider arm segment and extending outwardly from the slider to a sensor arm segment.

In another aspect, a sensor attachment module may be provided by interchangeable sensor holders and may be selectively installed to the arm via the sensor arm segment.

In another aspect, the interchangeable sensor holders may provide functionality for an intraoral horizontal bitewing view, an intraoral vertical bitewing view, an intraoral endodontic view, an intraoral anterior view, and/or an intraoral posterior view.

In another aspect, the sensor attachment module may further include a bite block.

In another aspect, the sensor attachment module may further include a removable sensor for intraoral x-ray imaging.

In another aspect, the sensor attachment module may further include a compression element having elastic properties removably attached to the interchangeable sensor holders. The sensor attachment module may additionally include a removable sensor for intraoral x-ray imaging, which may be reversibly attached to the sensor attachment module via the compression element.

In another aspect, the interchangeable sensor holders may further include a first sensor holder portion and a second sensor holder portion. In some configurations, at least part of the first sensor holder portion may linearly move in relation to the second sensor holder portion to selectively hold the removable sensor via compression.

In another aspect, the perimeter length of material may be substantially circumferential.

In another aspect, the aiming module may include at least one section marking to indicate the guide rail section to which the slider is locatable.

In another aspect, the notches may be provided by a change in guide rail depth in an otherwise continuous surface of the guide rail.

In another aspect, the slider may include at least one protruded slider notch that corresponds with at least one depressed guide rail notch of the guide rail.

In another aspect, the slider may include at least one depressed slider notch that corresponds with at least one protruded guide rail notch of the guide rail.

In another aspect, the arm may further include a wire receiving inlet to removably hold a communication wire.

In another aspect, the arm may further include a bend located between the slider arm segment and the sensor arm segment.

In another aspect, the bend may be approximately ninety-degrees. A wire receiving inlet may be provided at the bend to removably hold a communication wire.

In an alternative configuration, an adjustable x-ray sensor holder apparatus may be provided that includes an aiming module, slider, arm, and sensor attachment module. The aiming module may include a perimeter length of material having a substantial aperture through which x-ray imaging may be oriented and a guide rail located on a portion of the perimeter length of material. The guide rail may include notches located substantially along a guide rail length of the guide rail relative to guide rail sections. The notches may be provided by a change in guide rail depth on an otherwise continuous surface of the guide rail. The slider may be selectively positioned about one of the guide rail sections. The arm may extend outwardly from the slider and have a slider arm segment distal to a sensor arm segment. The sensor attachment module may be provided by interchangeable sensor holders selectively installed to the arm via the sensor arm segment. The interchangeable sensor holders may provide functionality for an intraoral horizontal bitewing view, an intraoral vertical bitewing view, an intraoral endodontic view, an intraoral anterior view, and/or an intraoral posterior view.

In another aspect, the sensor attachment module may further include a removable sensor for intraoral x-ray imaging.

In another aspect, the sensor attachment module may further include a compression element having elastic properties removably attached to the interchangeable sensor holders to reversibly hold the removable sensor.

In one embodiment, a method of using an adjustable x-ray sensor holder apparatus may be provided. The method may include the step of (a) orienting an aiming module. The aiming module may include a perimeter length of material having a substantial aperture and a guide rail located on a portion of the perimeter length of material that comprises notches located substantially along a guide rail length of the guide rail. The method may include the step of (b) positioning a slider about the guide rail. The method may include the step of (c) positioning a depth of insertion of the arm within the slider, the arm comprising a sensor arm segment distal to a slider arm segment. The method may include the step of (d) configuring a sensor attachment module to the sensor arm segment of the arm for intraoral x-ray imaging, the sensor attachment module further comprising a sensor holder.

In another aspect, the method may include the step of (e) attaching a sensor to the sensor attachment module via compression. The method may include the step of (f) positioning at least part of the adjustable x-ray sensor holder apparatus for the intraoral x-ray imaging. The method may include the step of (g) aiming an x-ray machine to the sensor via the aiming module.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a perspective view of an adjustable x-ray sensor holder apparatus in an intraoral anterior configuration, according to an embodiment of this disclosure.

FIG. 2 is a perspective view of an adjustable x-ray sensor holder apparatus in an intraoral posterior configuration, according to an embodiment of this disclosure.

FIG. 3 is a perspective view of an adjustable x-ray sensor holder apparatus in an intraoral endodontic configuration, according to an embodiment of this disclosure.

FIG. 4 is a perspective view of an adjustable x-ray sensor holder apparatus in an intraoral bitewing configuration, according to an embodiment of this disclosure.

FIG. 5 is an exploded perspective view of an intraoral posterior sensor holder, according to an embodiment of this disclosure.

FIG. 6 is a perspective view of an aiming module, according to an embodiment of this disclosure.

FIG. 7 is a perspective view of an arm, according to an embodiment of this disclosure.

FIG. 8 is a perspective view of an adjustable x-ray sensor holder apparatus in use, according to an embodiment of this disclosure.

FIG. 9 is an exploded perspective view of an intraoral bitewing sensor holder, according to an embodiment of this disclosure.

FIG. 10 is a flow chart view of using a universal digital dental x-ray sensor holder with adjustable aiming apparatus, according to an embodiment of this disclosure.

FIG. 11 is a flow chart view of an installation of a sensor to a universal digital dental x-ray sensor holder with adjustable aiming apparatus, according to an embodiment of this disclosure.

### DETAILED DESCRIPTION

The following disclosure is provided to describe various embodiments of a universal digital dental x-ray sensor holder with adjustable aiming apparatus. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term sensor, as it is used throughout this disclosure, is defined as a device that assists in taking digital x-ray images of a patient's teeth. The term guide rail, as it is used throughout this disclosure, is defined as an elongated piece of material that may comprise notches that guides the slider. The term notch, as it is used throughout this disclosure, is defined as a change in depth in an otherwise continuous surface of the guide rail.

The term anterior, as it is used throughout this disclosure, is defined as an x-ray view that may capture the maxillary and mandibular canines, lateral incisors, and central incisors. The term posterior, as it is used throughout this disclosure, is defined as an x-ray view that may capture the maxillary and mandibular premolars and molars. The term vertical bitewing, as it is used throughout this disclosure, is defined as an x-ray view that may show the upper and lower teeth in one area of the mouth, particularly operating in a plane perpendicular to the horizon. The term horizontal bitewing, as it is used throughout this disclosure, is defined as an x-ray view that may show the upper and lower teeth in one area of the mouth, particularly operating in a plane parallel to the horizon. The term endodontic, as it is used throughout this disclosure, is defined as an x-ray view that may capture one or more teeth, including the crown, roots, periodontal ligament space, and surrounding bone.

Various aspects of the present disclosure will now be described in detail, without limitation. In the following disclosure, a universal digital dental x-ray sensor holder with adjustable aiming apparatus will be discussed. Those of skill in the art will appreciate alternative labeling of the universal digital dental x-ray sensor holder with adjustable aiming apparatus as an adjustable x-ray holder apparatus, x-ray holder apparatus, x-ray aiming apparatus, moveable x-ray sensor housing, apparatus for the assistance of x-ray sensor positioning refinement, adjustable x-ray sensor holder apparatus, the invention, the apparatus, or other similar names. Similarly, those of skill in the art will appreciate alternative labeling of the universal digital dental x-ray sensor holder with adjustable aiming apparatus as a method for adjusting an x-ray holder apparatus, operation for positioning an adjustable x-ray aiming apparatus for imaging within the oral cavity of a user, technique for moving an x-ray sensor in relation to the oral cavity of a user using an adjustable holder apparatus, method, operation, the invention, or other similar names. Skilled readers should not view the inclusion of any alternative labels as limiting in any way.

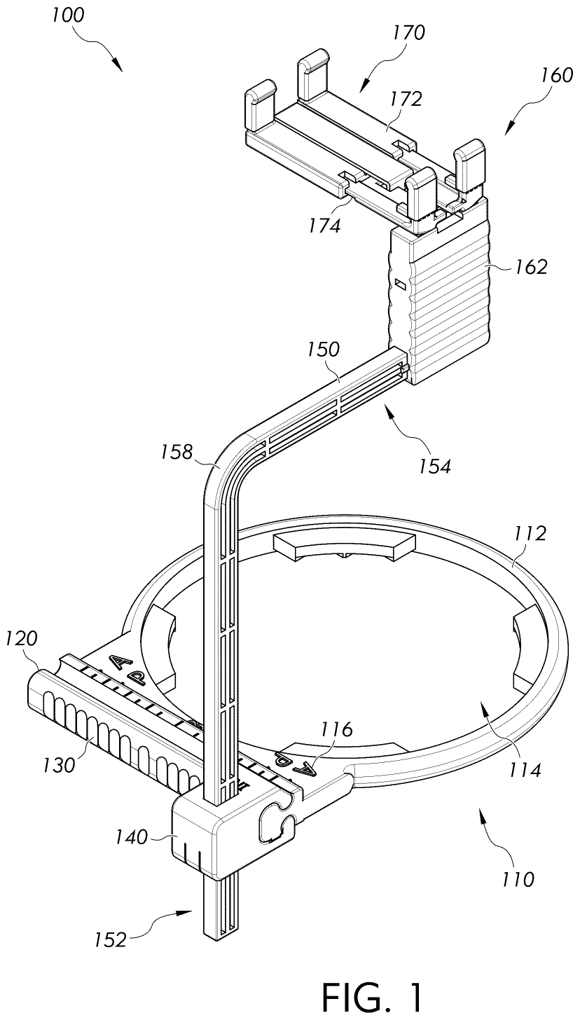

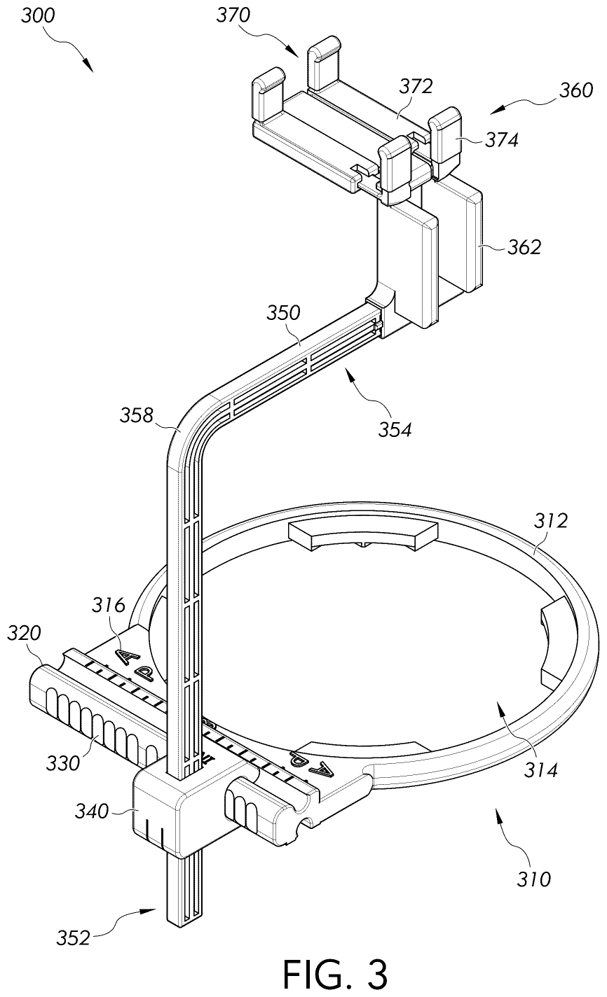

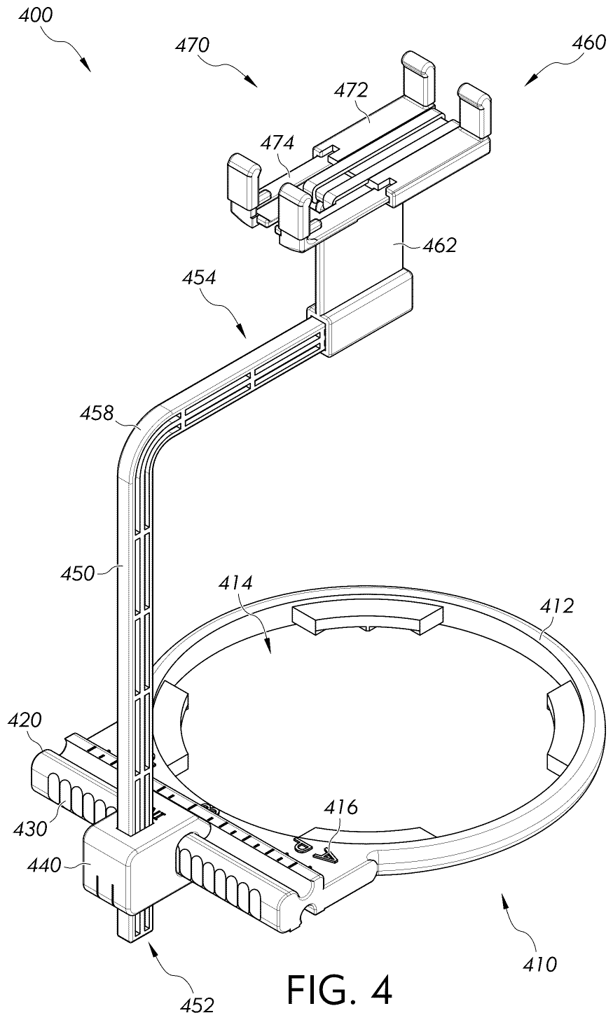

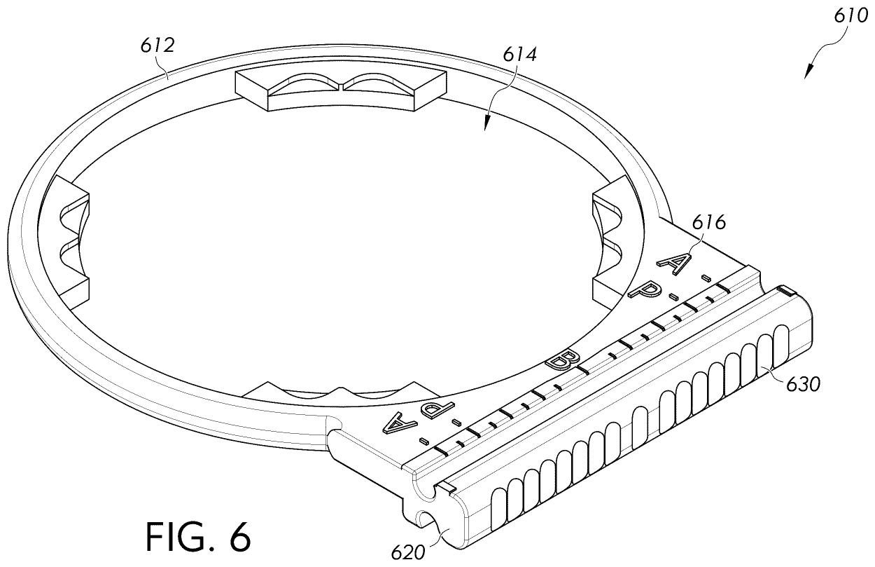

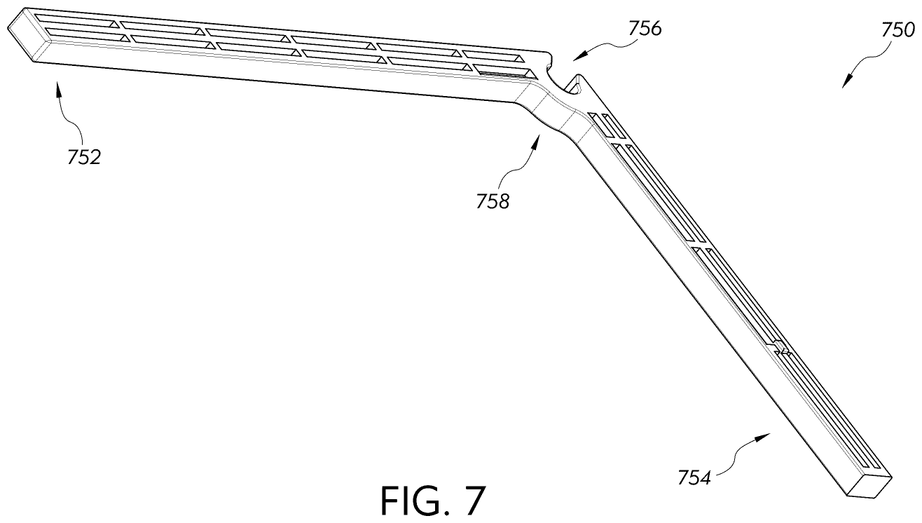

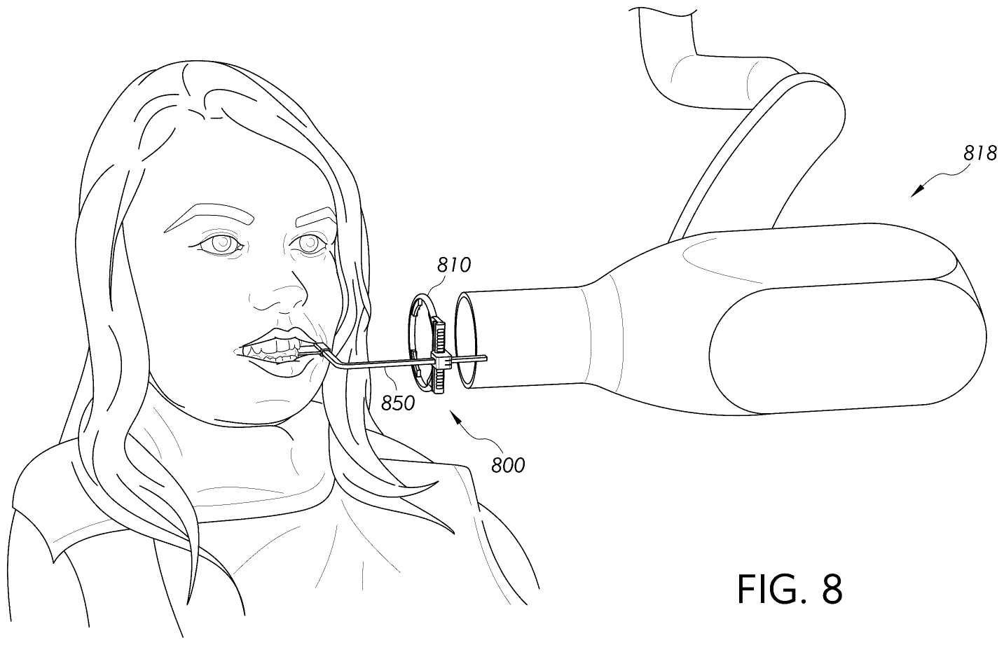

Referring now to FIGS. 1-11, a universal digital dental x-ray sensor holder with adjustable aiming apparatus enabled by this disclosure will now be discussed in more detail. In one embodiment, a universal digital dental x-ray sensor holder with adjustable aiming apparatus 100, 200, 300, 400, 800, may include an aiming module 110, 210, 310, 410, 610, 810, guide rail 120, 220, 320, 420, 620, slider 140, 240, 340, 440, arm 150, 250, 350, 450, 750, 850, sensor attachment module 160, 260, 360, 460, 560, 960, and interchangeability of same, sensors, and additional components that will be discussed in greater detail below. An illustrative universal digital dental x-ray sensor holder with adjustable aiming apparatus 100, 200, 300, 400, 800, may operate one or more of these components interactively with one or more other component for holding a digital dental x-ray sensor in a desired location via an apparatus enabled by this disclosure. In various embodiments enabled by this disclosure, an adjustable aiming ring may be used with a digital dental x-ray holder that can be fine tuned to fit various sizes of sensors to increase sensor accuracy due to improved positioning.

In general, as enabled by this disclosure, a universal digital dental x-ray sensor holder with adjustable aiming apparatus 100, 200, 300, 400, 800, may assist in aiming a digital x-ray imaging machine 818, while at least part of the apparatus 100, 200, 300, 400, 800, is positioned at least partially inside a patient's mouth.

In various embodiments, an illustrative x-ray sensor holder apparatus 100, 200, 300, 400, 800, may be made of one or more plastics, one or more metals, one or more woods, etc., or a combination thereof. Those skilled in the art, however, will appreciate the various materials that may be used to make up the x-ray sensor holder apparatus after having the benefit of this disclosure.

The aiming module will now be discussed in greater detail. FIGS. 1-4, 6, and 8 highlight examples of the aiming module, which may also be shown in other figures.

In some embodiments, the aiming module 110, 210, 310, 410, 610, 810, may generally comprise a perimeter length of material 112, 212, 312, 412, 612, a substantial aperture 114, 214, 314, 414, 614, and a guide rail 120, 220, 320, 420, 620. Those skilled in the art will appreciate the variations of the perimeter length of material 112, 212, 312, 412, 612, the substantial aperture 114, 214, 314, 414, 614, and the guide rail 120, 220, 320, 420, 620, being included or removed through various embodiments.

The aiming module 110, 210, 310, 410, 610, 810, may provide assistance for advantageously orienting an x-ray imaging machine 818, towards a patient's oral cavity. In the same or different embodiments, the aiming module 110, 210, 310, 410, 610, 810, may be used as a visual guide for aiming the x-ray imaging machine 818, while part of the sensor attachment module 160, 260, 360, 460, 560, 960, is blocked from the user's view while part of the sensor attachment module 160, 260, 360, 460, 560, 960, is in the patient's oral cavity.

The perimeter of length will now be discussed in greater detail. FIGS. 1-4, 6 and 8 highlight examples of the aiming module 110, 210, 310, 410, 610, 810, which may also be shown in other figures.

In a variety of embodiments, the perimeter length of material 112, 212, 312, 412, 612, may be circumferential or polygonal. Possible additional embodiments may include three sides, four sides, five sides, six sides, seven sides, eight sides, nine sides, ten sides, eleven sides, twelve sides, thirteen sides, fourteen sides, fifteen sides, sixteen sides, seventeen sides, eighteen sides, nineteen sides, twenty sides, and/or more sides. Those skilled in the art will appreciate the countless number of sides that the perimeter length of material 112, 212, 312, 412, 612, may have. Furthermore, skilled artisans will be presumed to make the perimeter length of material 112, 212, 312, 412, 612, to include polygons to a theoretical nearly infinite number of sides.

The perimeter length of material 112, 212, 312, 412, 612, may be a variety of sizes. In one or more embodiments, the perimeter length of material 112, 212, 312, 412, 612, may advantageously be an equivalent size to a tube head of an x-ray imaging machine 818. Those skilled in the art will appreciate the various sizes of the perimeter length of material 112, 212, 312, 412, 612 that may be possible after having the benefit of this disclosure.

In some embodiments, the perimeter length of material 112, 212, 312, 412, 612, may have a substantial aperture 114, 214, 314, 414, 614. The substantial aperture 114, 214, 314, 414, 614, may be used, in combination with virtually any other elements described herein, to guide the x-ray machine. In the same or different embodiments, the substantial aperture 114, 214, 314, 414, 614, may advantageously allow x-rays to pass from the x-ray imaging machine 818, to a removable sensor 264, inside the patient's mouth without further obstruction from the apparatus 100, 200, 300, 400, 800. Those skilled in the art will appreciate the assorted sizes and shapes of the substantial aperture 114, 214, 314, 414, 614. In certain embodiments, the perimeter length of material 112, 212, 312, 412, 612, may comprise more than one substantial aperture 114, 214, 314, 414, 614.

The perimeter length of material 112, 212, 312, 412, 612, may further comprise flaps. The flaps may be protrusions from the length of material. Flaps may be situated on virtually any side of the perimeter length of material 112, 212, 312, 412, 612. In one or more embodiments, the flaps may be located on the same side of the substantial aperture 114, 214, 314, 414, 614. In some embodiments, there may be more than one flap located on the perimeter length of the material. For example, there may be four evenly spaced flaps protruding from the perimeter length of material 112, 212, 312, 412, 612. Those skilled in the art will appreciate the various number, lengths, and spacings of the flaps that may be included by various embodiments enabled by this disclosure and that are consistent with the scope and spirit of this disclosure.

The guide rail will now be discussed in greater detail. FIGS. 1-4 and 6 highlight examples of the guide rail, which may also be shown in other figures.

In various embodiments, the guide rail 120, 220, 320, 420, 620, may be located on a portion of the perimeter length of material 112, 212, 312, 412, 612. The guide rail 120, 220, 320, 420, 620, may be a substantially flat piece of material that may be tangential to the perimeter length of material 112, 212, 312, 412, 612. In other embodiments, the guide rail 120, 220, 320, 420, 620, may be about parallel to the perimeter length of material 112, 212, 312, 412, 612, however, those skilled in the art will appreciate the various orientations of the guide rail 120, 220, 320, 420, 620 may be used, as compared to the perimeter length of material 112, 212, 312, 412, 612, without limitation. The guide rail 120, 220, 320, 420, 620, may be a different thickness as the rest of the perimeter length of material 112, 212, 312, 412, 612. The guide rail 120, 220, 320, 420, 620, may have a generally cylindrical volume, while the rest of the aiming module 110, 210, 310, 410, 610, 810, is generally flat. However, skilled artisans will appreciate the virtually unlimited variations of volumes that the guide rail 120, 220, 320, 420, 620, may take on.

The guide rail 120, 220, 320, 420, 620, may further comprise a continuous surface. In various embodiments, one side of the guide rail 120, 220, 320, 420, 620, may comprise one flat surface, while the rest of the guide rail 120, 220, 320, 420, 620, holds a generally cylindrical volume. In other embodiments, the guide rail 120, 220, 320, 420, 620, may comprise few and/or no flat surfaces, while, in other embodiments, the guide rail 120, 220, 320, 420, 620, may comprise exclusively and/or mostly flat surfaces. Nonetheless, skilled artisans will appreciate the number of flat and non-flat surfaces along the guide rail 120, 220, 320, 420, 620.

In some embodiments, the guide rail 120, 220, 320, 420, 620, may have guide rail sections. A number of guide rail sections may correspond with substantially the entire width of the guide rail 120, 220, 320, 420, 620. Thus, in some embodiments, there may be a number of total guide rail sections that correspond with the entire width of the guide rail 120, 220, 320, 420, 620. Those skilled in the art will appreciate the virtually unlimited number of guide rail sections that may correspond with the width of the guide rail 120, 220, 320, 420, 620. Guide rail sections may advantageously assist in noting the position of the sensor attachment module 160, 260, 360, 460, 560, 960, and corresponding parts. Guide rail sections may also be advantageously used for correlation purposes of other corresponding parts of the adjustable x-ray sensor holder apparatus 100, 200, 300, 400, 800. Skilled artisans will appreciate the vast amount of purposes that may exist for the guide rail sections.

In various embodiments, the guide rail sections may further encompass one or more notches 130, 230, 330, 430, 630. There may be a correlation between the notches 130, 230, 330, 430, 630, in each guide rail section to the preferred location of at least the sensor attachment module 160, 260, 360, 460, 560, 960. Skilled artisans will appreciate the various correlations that may exist between the notches 130, 230, 330, 430, 630, in each guide rail section to the location of other corresponding pieces of the apparatus 100, 200, 300, 400, 800.

In some embodiments, the aiming module 110, 210, 310, 410, 610, 810, may further include at least one section marking 116, 216, 316, 416, 616. The at least one section marking 116, 216, 316, 416, 616, may assist in indicating the location of the slider 140, 240, 340, 440, along the guide rail 120, 220, 320, 420, 620. In the same or other embodiments, a section marking may correspond with each guide rail section. Skilled artisans will appreciate the several ways the section marking may assist in the positioning of other corresponding parts of the apparatus 100, 200, 300, 400, 800.

In one or more embodiments, the guide rail 120, 220, 320, 420, 620, may include a mechanism for the slider 140, 240, 340, 440, to move via the guide rail 120, 220, 320, 420, 620. The mechanism may assist the slider 140, 240, 340, 440, to smoothly move via the guide rail 120, 220, 320, 420, 620, while also optionally be able to be temporarily locked via the notch correlation between the slider 140, 240, 340, 440, and the guide rail 120, 220, 320, 420, 620. In the same or other embodiments, the guide rail 120, 220, 320, 420, 620, may only comprise a rail for the slider 140, 240, 340, 440, to correspond to. Those skilled in the art will appreciate the various mechanisms that may exist on the guide rail 120, 220, 320, 420, 620, or aiming module 110, 210, 310, 410, 610, 810, for the slider 140, 240, 340, 440, to move via the guide rail 120, 220, 320, 420, 620.

In various embodiments, the guide rail 120, 220, 320, 420, 620, may further comprise notches 130, 230, 330, 430, 630. The guide rail 120, 220, 320, 420, 620, may include a rail for the slider 140, 240, 340, 440, to move along as well as the notches 130, 230, 330, 430, 630, for the slider 140, 240, 340, 440, to be selectively positioned via the length of the guide rail 120, 220, 320, 420, 620. In other embodiments, the notches 130, 230, 330, 430, 630, may be located on different sections of the aiming module 110, 210, 310, 410, 610, 810. The notches 130, 230, 330, 430, 630, may advantageously correspond with the slider 140, 240, 340, 440, or other related parts to selectively position the slider 140, 240, 340, 440, to the aiming module 110, 210, 310, 410, 610, 810. However, skilled artisans will appreciate the various advantages that the notches 130, 230, 330, 430, 630, may have during the regular use of the adjustable x-ray sensor holder apparatus 100, 200, 300, 400, 800.

The notches 130, 230, 330, 430, 630, of the guide rail 120, 220, 320, 420, 620, may be provided by a change in depth in an otherwise continuous surface of the guide rail 120, 220, 320, 420, 620. In some embodiments, the notches 130, 230, 330, 430, 630, of the guide rail 120, 220, 320, 420, 620, may include at least one depressed guide rail notch of the guide rail 120, 220, 320, 420, 620. The at least one depressed guide rail notch of the guide rail 120, 220, 320, 420, 620, may correspond with at least one protruded slider notch of the slider 140, 240, 340, 440. In other embodiments, the notches 130, 230, 330, 430, 630, of the guide rail 120, 220, 320, 420, 620, may include at least one protruded guide rail notch of the guide rail. The at least one protruded guide rail notch of the guide rail 120, 220, 320, 420, 620, may correspond with at least one depressed slider notch of the slider 140, 240, 340, 440. In other embodiments, the notches 130, 230, 330, 430, 630, of the guide rail 120, 220, 320, 420, 620, may include at least one protruded guide rail notch of the guide rail 120, 220, 320, 420, 620. The at least one protruded guide rail notch of the guide rail 120, 220, 320, 420, 620, may interlock with at least one protruded slider notch of the slider 140, 240, 340, 440. Those skilled in the art will appreciate the virtually unlimited variations of how the notches 130, 230, 330, 430, 630, of the guide rail 120, 220, 320, 420, 620, may associate with the notches of the slider 140, 240, 340, 440.

The slider will now be discussed in greater detail. FIGS. 1-4, 6, and 8 highlight examples of the slider, which may also be shown in other figures.

In some embodiments, the slider 140, 240, 340, 440, may advantageously be selectively positioned along the aiming module 110, 210, 310, 410, 610, 810. In the same or different embodiments, the slider 140, 240, 340, 440, may be selectively positioned along the length of the guide rail 120, 220, 320, 420, 620. As discussed previously, the slider 140, 240, 340, 440, may include at least one protruded notch or at least one depressed notch. The at least one notch of the slider 140, 240, 340, 440, may correspond with at least one notch of the guide rail 120, 220, 320, 420, 620. Those skilled in the art will appreciate the numerous ways the slider 140, 240, 340, 440, may be selectively positioned along the aiming module 110, 210, 310, 410, 610, 810, including, but not limited to, via a rail, notches, or other mechanism after having the benefit of this disclosure.

In various embodiments, the slider 140, 240, 340, 440, may further comprise at least one aperture. Skilled artisans will appreciate the various number of apertures that may exist in the slider 140, 240, 340, 440. In the same or other embodiments, the at least one aperture may advantageously correspond with the arm 150, 250, 350, 450, 750, 850, of the adjustable x-ray sensor holder apparatus 100, 200, 300, 400, 800. The arm 150, 250, 350, 450, 750, 850, may operatively connect to the slider 140, 240, 340, 440, at a variable arm depth. In some embodiments, there may be additional mechanisms to lock the arm 150, 250, 350, 450, 750, 850, in place after the user has determined the optimal variable arm depth. These mechanisms include, but are not limited to, ball lock, compression lock, slip joint, or stop lock, however, skilled artisans will appreciate various additional mechanisms that may exist to lock the arm 150, 250, 350, 450, 750, 850, in place via the slider 140, 240, 340, 440 that are consistent with the scope and spirit of this disclosure.

In other embodiments, the arm 150, 250, 350, 450, 750, 850, may be affixed to the slider 140, 240, 340, 440. The affixation of the arm 150, 250, 350, 450, 750, 850, to the slider 140, 240, 340, 440, may be done during manufacturing, however, those skilled in the art will appreciate the various point in times of which the arm 150, 250, 350, 450, 750, 850, may be affixed to the slider 140, 240, 340, 440.

The arm will now be discussed in greater detail. FIGS. 1-4, and 7-8 highlight examples of the arm, which may also be shown in other figures.

In various embodiments, the arm 150, 250, 350, 450, 750, 850, may extend from the slider 140, 240, 340, 440, to the sensor attachment module 160, 260, 360, 460, 560, 960. Skilled artisans will appreciate the various other points at which the arm 150, 250, 350, 450, 750, 850, may attach, including, but not limited to, on the perimeter length of material 112, 212, 312, 412, 612, or the guide rail 120, 220, 320, 420, 620.

In the same or other embodiments, the arm 150, 250, 350, 450, 750, 850, may comprise a sensor arm segment 154, 254, 354, 454, 754, and a slider arm segment 152, 252, 352, 452, 752. The sensor arm segment 154, 254, 354, 454, 754, may be distal from the slider arm segment 152, 252, 352, 452, 752. In similar embodiments, the sensor arm segment 154, 254, 354, 454, 754, encompasses half of the arm while the slider arm segment 152, 252, 352, 452, 752, encompasses the other half of the arm. The slider arm segment 152, 252, 352, 452, 752, may attach to the slider 140, 240, 340, 440, while the sensor arm segment 154, 254, 354, 454, 754, may attach to the sensor attachment module 160, 260, 360, 460, 560, 960, however, those skilled in the art will appreciate the various points at which both the sensor arm segment 154, 254, 354, 454, 754, and slider arm segment 152, 252, 352, 452, 752, may attach on the apparatus 100, 200, 300, 400, 800.

In various embodiments, the arm 150, 250, 350, 450, 750, 850, may further include at least one bend 158, 258, 358, 458, 758. The bend 158, 258, 358, 458, 758, may be located between the sensor arm segment 154, 254, 354, 454, 754, of the arm 150, 250, 350, 450, 750, 850, and the slider arm segment 152, 252, 352, 452, 752, of the arm 150, 250, 350, 450, 750, 850. In some embodiments, the bend 158, 258, 358, 458, 758, may be an about ninety-degree bend, however, skilled artisans will appreciate the bend 158, 258, 358, 458, 758, measuring anywhere between zero-degrees and three hundred and sixty-degrees may be provided, without limitation.

In other embodiments, the arm 150, 250, 350, 450, 750, 850, may also include a wire receiving inlet 756. The wire receiving inlet 756, may advantageously removably hold a communication wire 242. The communication wire 242 may extend from the sensor to the device that collects the x-ray imaging data. In some embodiments, the wire receiving inlet 756, may be located at the bend 158, 258, 358, 458, 758, of the arm 150, 250, 350, 450, 750, 850, however, those skilled in the art will appreciate the various locations of which the wire receiving inlet 756, may be located after having the benefit of this disclosure.

The sensor attachment module will now be discussed in greater detail. FIGS. 1-5 and 9 highlight examples of the sensor attachment module, which may also be shown in other figures.

In various embodiments, the sensor attachment module 160, 260, 360, 460, 560, 960, may comprise interchangeable sensor holders 170, 270, 370, 470, removable sensors, a compression element 566, 966, and a bite block 162, 262, 362, 462, 562, 962. The sensor attachment module 160, 260, 360, 460, 560, 960, may be interchangeable depending on which intraoral x-ray view is needed. Those skilled in the art will appreciate various additional elements that may be added to the sensor attachment module 160, 260, 360, 460, 560, 960 after having the benefit of this disclosure.

The sensor attachment modules 160, 260, 360, 460, 560, 960, may be interchangeable depending on the preferred intraoral x-ray imaging view. In some embodiments, the sensor attachment module 160, 260, 360, 460, 560, 960, may provide functionality for the following views: an intraoral horizontal bitewing view, an intraoral vertical bitewing view, an intraoral endodontic view, an intraoral anterior view, or an intraoral posterior view. The sensor attachment module 160, 260, 360, 460, 560, 960, for each view may comprise an interchangeable sensor holder, a bite block 162, 262, 362, 462, 562, 962, and a compression element 566, 966, as described herein. In the same or other embodiments, the sensor attachment module 160, 260, 360, 460, 560, 960, may also provide functionality for other periapical x-ray views.

In certain embodiments, the sensor arm segment 154, 254, 354, 454, 754, of the arm 150, 250, 350, 450, 750, 850, may be removably attached to a bite block 162, 262, 362, 462, 562, 962. Therein, the bite block 162, 262, 362, 462, 562, 962, may then be attached to the interchangeable sensor holders 170, 270, 370, 470. A compression element 566, 966, may then temporarily hold the removable sensor 264, in the interchangeable sensor holders 170, 270, 370, 470. However, skilled artisans will appreciate the numerous variations that may exist within the sensor attachment module 160, 260, 360, 460, 560, 960, including, but not limited to, the sensor arm segment 154, 254, 354, 454, 754, of the arm 150, 250, 350, 450, 750, 850, being directly attached to the interchangeable sensor holders 170, 270, 370, 470, which may be attached to a bite block 162, 262, 362, 462, 562, 962. Furthermore, in certain embodiments, the sensor attachment module 160, 260, 360, 460, 560, 960, may include interchangeable sensor holders 170, 270, 370, 470, with a compression element 566, 966, but no bite block. Those skilled in the art will appreciate the various elements that may or may not be included within the sensor attachment module 160, 260, 360, 460, 560, 960 in various other embodiments that are consistent with the scope and spirit of this disclosure, without limitation.

The interchangeable sensor holders will now be discussed in greater detail. FIGS. 1-4 highlight examples of the interchangeable sensor holders, which may also be shown in other figures.

In some embodiments, the interchangeable sensor holders 170, 270, 370, 470, may also interact with a compression element 566, 966, and a bite block 162, 262, 362, 462, 562, 962, both of which will be discussed in greater detail later.

In various embodiments, the interchangeable sensor holders 170, 270, 370, 470, may include a first sensor holder portion 172, 272, 372, 472, 572, 972, and second sensor holder portion 174, 274, 374, 474, 574, 974. Those skilled in the art, however, will appreciate the numerous sensor holder portions that may be added or subtracted to the interchangeable sensor holders 170, 270, 370, 470. In the same or other embodiments, the first sensor holder portion 172, 272, 372, 472, 572, 972, may linearly move in relation to the second sensor holder portion 174, 274, 374, 474, 574, 974. However, skilled artisans will appreciate several additional ways in which the first sensor holder portion 172, 272, 372, 472, 572, 972, may move in relation to the second sensor holder portion 174, 274, 374, 474, 574, 974 after having the benefit of this disclosure.

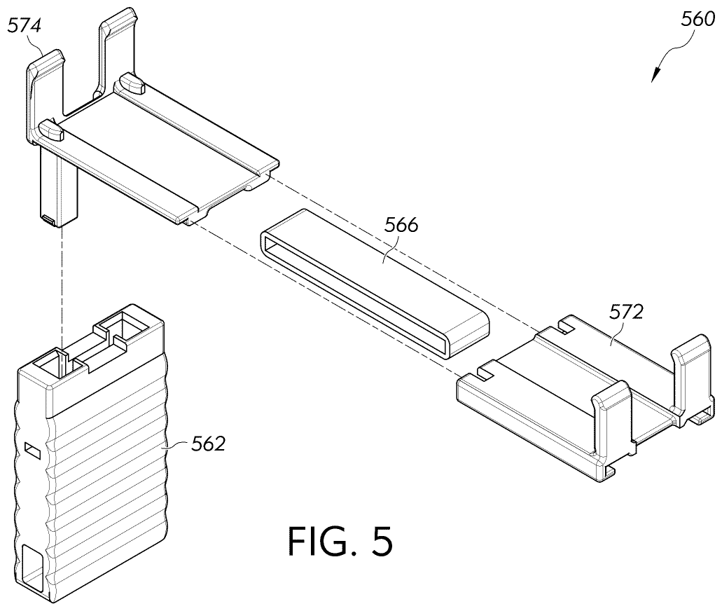

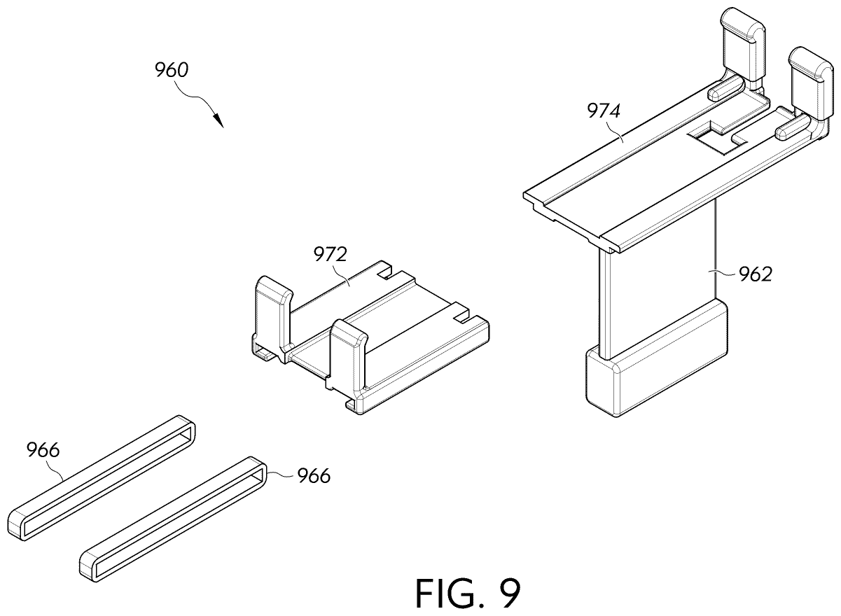

The compression element will now be discussed in greater detail. FIGS. 5 and 9 highlight an example of the compression element, which may also be shown in other figures.

In some embodiments, the compression element 566, 966, may assist in adding compression to the interchangeable sensor holders 170, 270, 370, 470. More specifically, the compression element 566, 966, may compress the first sensor holder portion 172, 272, 372, 472, 572, 972, and the second sensor holder portion 174, 274, 374, 474, 574, 974, towards each other. In the same or other embodiments, the compression element 566, 966, may further assist in holding the removable sensor 264, in place. Those skilled in the art will appreciate other advantages of the compression element 566, 966, in the sensor attachment module 160, 260, 360, 460, 560, 960 after having the benefit of this disclosure.

In various embodiments, the sensor attachment module 160, 260, 360, 460, 560, 960 may include more than one compression element, for example two compression elements 966, that may compress the first sensor holder portion 172, 272, 372, 472, 572, 972 and the second sensor holder portion 174, 274, 374, 474, 574, 974 towards each other. For example, a first compression element may compress a first right side of the first sensor holder portion 172, 272, 372, 472, 572, 972 towards the second right side of the second sensor holder portion 174, 274, 374, 474, 574, 974. A second compression element may compress a first left side of the first sensor holder portion 172, 272, 372, 472, 572, 972 towards a second left side of the second sensor holder portion 174, 274, 374, 474, 574, 974. In other embodiments, the compression element may be used such to only compress the right side or the left side of the first sensor holder portion towards the second sensor holder portion. Skilled artisans will realize the various number of compression elements that may be used, as well as their locations of potential use, after having the benefit of this disclosure.

In certain embodiments, the compression element 566, 966 may have elastic properties. Skilled artisans will appreciate the various materials that may be used as a compression element, including, but not limited to, a rubber band or a spring.

The bite block will now be discussed in greater detail. FIGS. 1-5 and 9 highlight examples of the bite block, which may also be shown in other figures.

In certain embodiments, the bite block 162, 262, 362, 462, 562, 962, may be included in the sensor attachment module 160, 260, 360, 460, 560, 960. The bite block 162, 262, 362, 462, 562, 962, may be used to advantageously block the patient from biting on the other parts of the apparatus 100, 200, 300, 400, 800. The bite block 162, 262, 362, 462, 562, 962, may be made of a variety of materials including plastics or metals, but those skilled in the art will appreciate a variety of additional materials that may be used to construct the bite block 162, 262, 362, 462, 562, 962, which are intended to be included within the scope of this disclosure. In certain embodiments, more than one bite block 162, 262, 362, 462, 562, 962, may exist within the sensor attachment module 160, 260, 360, 460, 560, 960. Skilled artisans will appreciate the numerous variations of the number of bite blocks needed to protect the apparatus 100, 200, 300, 400, 800, from patient harm. In the same or other embodiments, the bite block 162, 262, 362, 462, 562, 962, may be a substantially rectangular prism, however, those skilled in the art will appreciate the various shapes the bite block may be, including, but not limited to, a cylinder.

Additionally, in some embodiments, the bite block 162, 262, 362, 462, 562, 962 may be of virtually any size or thickness, without limitation. In these embodiments, the bite block 162, 262, 362, 462, 562, 962 may be configured with a desired size and/or thickness to fit the intended application while in use. For example, a dentist may prefer a thinner bite block 162, 262, 362, 462, 562, 962 that would allow a better view of a bite performed by a patient subject to the imaging. In one embodiment, the bite block 162, 262, 362, 462, 562, 962 may be around 0.16 mm thick, which may advantageously allow a user, such as a dentist, to view an intraoral bite. In another embodiment, the bite block 162, 262, 362, 462, 562, 962 may be around 0.60 mm thick, which may allow a user, such as a dentist, to prevent the patient from closing their mouth fully. However, those skilled in the art will appreciate additional embodiments in which the various widths of the bite block may fit the desired application, imaging objectives, and/or sensor parameters after having the benefit of this disclosure, without limitation.

In other embodiments, the bite block 162, 262, 362, 462, 562, 962 may be affixed to certain parts of the sensor attachment module 160, 260, 360, 460, 560, 960, without limitation. In some embodiments, the bite block may be attached to the second sensor holder portion 174, 274, 374, 474, 574, 974.

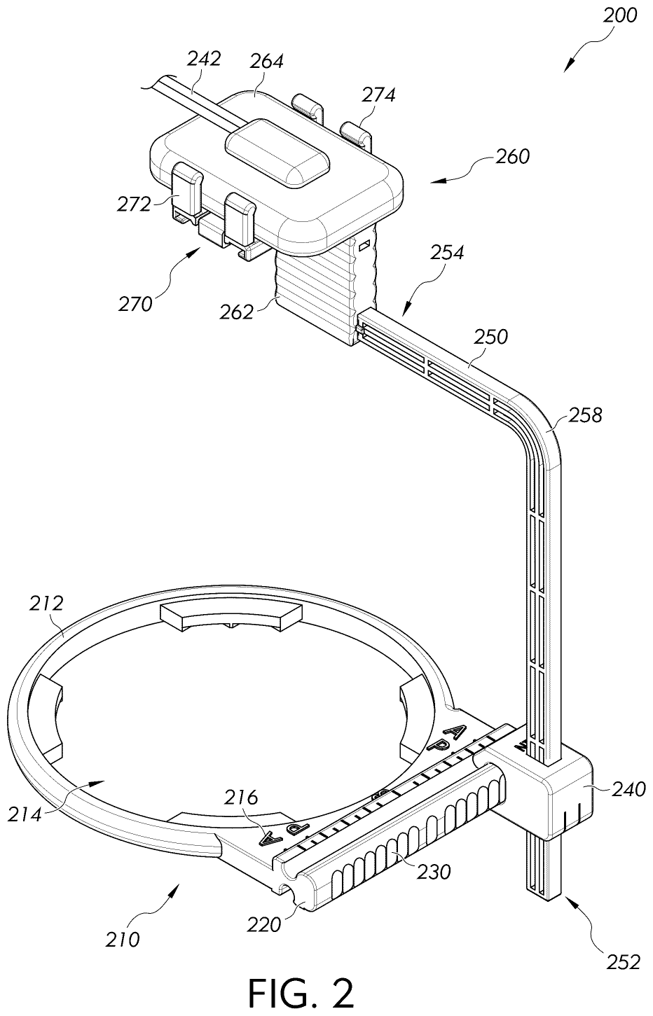

The removable sensor will now be discussed in greater detail. FIG. 2 highlights an example of the removable sensor, which may also be shown in other figures.

In some embodiments, the removable sensor 264, may be a dental intraoral x-ray sensor. As previously mentioned, the removable sensor 264, may be connected to a communication wire 242. In the same or different embodiments, the removable sensor 264, may be removably positioned in the interchangeable sensor holders 170, 270, 370, 470. Furthermore, the removable sensor 264, may be of a variety of sizes, particularly to align with a patient's mouth size from adolescence to adulthood. Those skilled in the art will appreciate the virtually unlimited sizes of the removable sensors that may be used. In order to protect the removable sensor 264, when in use and in a patient's mouth, the user may optionally use a protective cover. The protective cover may partially seal the removable sensor 264, and at least part of the communication wire 242.

In operation, a method may be provided for holding a digital dental x-ray sensor in a desired location by an apparatus 100, 200, 300, 400, 800, enabled by this disclosure. Those of skill in the art will appreciate that the following methods are provided to illustrate an embodiment of the disclosure and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

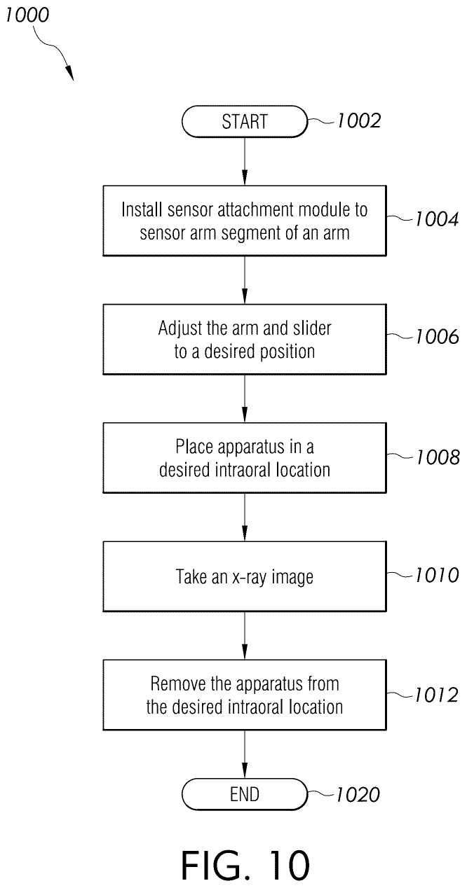

Referring now to flowchart 1000 of FIG. 10, an illustrative method for using a universal digital dental x-ray sensor holder with adjustable aiming apparatus will be described, without limitation. Starting with block 1002, the operation may begin by installing the sensor attachment to a sensor arm segment of an arm (block 1004). The arm and slider may then be adjusted to a desired position (block 1006). The apparatus may be placed in a desired intraoral location (block 1008). An x-ray image may then be taken (block 1010). The apparatus may be removed from the desired intraoral location (block 1012). The operation may then terminate at block 1020.

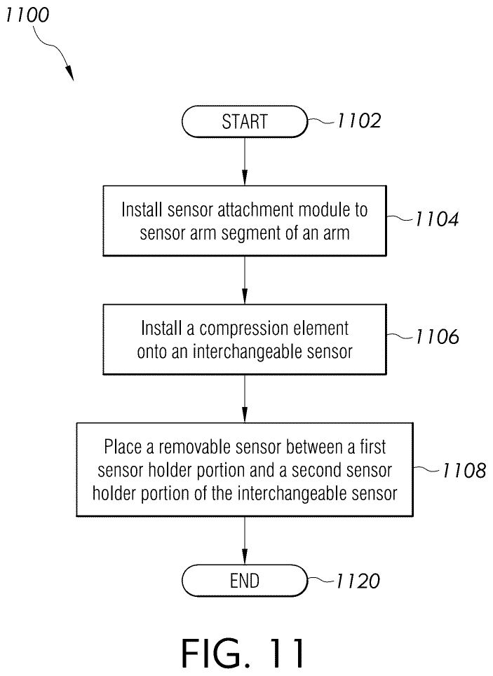

Referring now to flowchart 1100 of FIG. 11, an illustrative method for installing a sensor to a universal digital dental x-ray sensor holder with adjustable aiming apparatus will be described, without limitation. Starting with block 1102, the operation may begin by installing a sensor attachment module to a sensor arm segment of an arm (block 1104). A compression element may then be installed onto the interchangeable sensor holder (block 1106). A removable sensor may be placed between a first sensor holder portion and second sensor holder portion of an interchangeable sensor holder (block 1108). The operation may then terminate at block 1120.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. An adjustable x-ray sensor holder apparatus comprising:
an aiming module further comprising:
a perimeter length of material having a substantial aperture through which x-ray imaging may be oriented,
a guide rail located on a portion of the perimeter length of material, and
wherein the guide rail comprises notches located substantially along a guide rail length of the guide rail relative to guide rail sections;
a slider selectively positioned about one of the guide rail sections; and
an arm operatively connected to the slider at a variable arm depth via a slider arm segment and extending outwardly from the slider to a sensor arm segment.

2. The holder apparatus of claim 1, wherein a sensor attachment module is provided by interchangeable sensor holders selectively installed to the arm via the sensor arm segment.

3. The holder apparatus of claim 2, wherein the interchangeable sensor holders provide functionality for an intraoral horizontal bitewing view, an intraoral vertical bitewing view, an intraoral endodontic view, an intraoral anterior view, and/or an intraoral posterior view.

4. The holder apparatus of claim 2, wherein the sensor attachment module further comprises a bite block.

5. The holder apparatus of claim 2, wherein the sensor attachment module further comprises a removable sensor for intraoral x-ray imaging.

6. The holder apparatus of claim 2, wherein the sensor attachment module further comprises:
a compression element having elastic properties removably attached to the interchangeable sensor holders; and
a removable sensor for intraoral x-ray imaging reversibly attached to the sensor attachment module via the compression element.

7. The holder apparatus of claim 6, wherein the interchangeable sensor holders further comprise:
a first sensor holder portion;
a second sensor holder portion; and
wherein at least part of the first sensor holder portion linearly moves in relation to the second sensor holder portion to selectively hold the removable sensor via compression.

8. The holder apparatus of claim 1, wherein the perimeter length of material is substantially circumferential.

9. The holder apparatus of claim 1, wherein the aiming module includes at least one section marking to indicate the guide rail section to which the slider is locatable.

10. The holder apparatus of claim 1, wherein the notches are provided by a change in guide rail depth in an otherwise continuous surface of the guide rail.

11. The holder apparatus of claim 10, wherein the slider comprises at least one protruded slider notch that corresponds with at least one depressed guide rail notch of the guide rail.

12. The holder apparatus of claim 10, wherein the slider includes at least one depressed slider notch that corresponds with at least one protruded guide rail notch of the guide rail.

13. The holder apparatus of claim 1, wherein the arm further comprises a wire receiving inlet to removably hold a communication wire.

14. The holder apparatus of claim 1, wherein the arm further comprises a bend located between the slider arm segment and the sensor arm segment.

15. The holder apparatus of claim 14, wherein the bend is approximately ninety-degrees, and;
wherein a wire receiving inlet is provided at the bend to removably hold a communication wire.

16. An adjustable x-ray sensor holder apparatus comprising:
an aiming module further comprising:
a perimeter length of material having a substantial aperture through which x-ray imaging may be oriented,
a guide rail located on a portion of the perimeter length of material,
wherein the guide rail comprises notches located substantially along a guide rail length of the guide rail relative to guide rail sections, and
wherein the notches are provided by a change in guide rail depth in an otherwise continuous surface of the guide rail;
a slider selectively positioned about one of the guide rail sections;
an arm extending outwardly from the slider, the arm having a slider arm segment distal to a sensor arm segment;
a sensor attachment module provided by interchangeable sensor holders selectively installed to the arm via the sensor arm segment; and
wherein the interchangeable sensor holders provide functionality for an intraoral horizontal bitewing view, an intraoral vertical bitewing view, an intraoral endodontic view, an intraoral anterior view, and/or an intraoral posterior view.

17. The holder apparatus of claim 16, wherein the sensor attachment module further comprises a removable sensor for intraoral x-ray imaging.

18. The holder apparatus of claim 17, wherein the sensor attachment module, further comprises:
a compression element having elastic properties removably attached to the interchangeable sensor holders to reversibly hold the removable sensor.

19. A method of using an adjustable x-ray sensor holder apparatus comprising:
(a) orienting an aiming module, the aiming module comprising:
a perimeter length of material having a substantial aperture, and
a guide rail located on a portion of the perimeter length of material that comprises notches located substantially along a guide rail length of the guide rail;
(b) positioning a slider about the guide rail;
(c) positioning a depth of insertion of the arm within the slider, the arm comprising a sensor arm segment distal to a slider arm segment; and
(d) configuring a sensor attachment module to the sensor arm segment of the arm for intraoral x-ray imaging, the sensor attachment module further comprises a sensor holder.

20. The method of claim 19, further comprising:
(e) attaching a sensor to the sensor attachment module via compression;
(f) positioning at least part of the adjustable x-ray sensor holder apparatus for the intraoral x-ray imaging; and
(g) aiming an x-ray machine to the sensor via the aiming module.
